(19) United States
(12) Patent Application Publication
(10) Pub. No.: US 2019/0056870 A1
(43) Pub. Date: Feb. 21, 2019

(54) Reducing solid state Storage device read tail latency

(71) Applicant: ScaleFlux, Inc., San Jose, CA (US)

(72) Inventors: Fei Sun, Irvine, CA (US); Jinjin He, Santa Clara, CA (US); Qi Wu, San Jose, CA (US)

(21) Appl. No.: 15/998,430

(22) Filed: Aug. 15, 2018

Related U.S. Application Data
(60) Provisional application No. 62/545,941, filed on Aug. 15, 2017.

(51) Int. Cl. G06F 3/06

(52) U.S. Cl. CPC G06F 3/0611; G06F 3/064; G06F 3/0613; G06F 3/0659; G06F 3/0653

(57) ABSTRACT

A storage device, infrastructure, and associated method for managing request queue to reduce read tail latencies. A disclosed storage device is disclosed that includes: a set of flash memory chips; and a controller that schedules request from a host using a set of request queues, wherein the controller includes a queue manager that: reorders high priority read requests over low priority write requests in each request queue; suspends low priority write requests to process high priority read requests; and limits a number of low priority write requests allowed in each request queue to a threshold value smaller than a size of each request queue.

### TECHNICAL FIELD

The present invention relates to the field of solid-state data storage devices, and particularly to reducing the read tail latency of solid state data storage devices.

### BACKGROUND

Solid-state data storage devices, which use non-volatile NAND flash memory technology, are being pervasively deployed in various computing and storage systems. In addition to single or multiple NAND flash memory chips, each solid state data storage device must contain a controller that manages all the NAND flash memory chips. NAND flash memory cells are organized in an array→block→page hierarchy, where one NAND flash memory array is partitioned into a large number (e.g., thousands) of blocks, and each block contains a certain number (e.g., 256) of pages. The size of each flash memory physical page typically ranges from 8 kb to 32 kB, and the size of each flash memory block is typically tens of MBs. Data are programmed and fetched in the unit of page. However, flash memory cells must be erased before being re-programmed, and the erase operation is carried out in the unit of block (i.e., all the pages within the same block must be erased at the same time).

Compared with hard disk drives (HDDs), flash-based solid state storage devices can achieve significantly higher average I/O throughput and lower average I/O access latency. In addition to average I/O throughput and latency, many applications (e.g., databases) have stringent requirements on read tail latency (e.g., 99^{th} percentile read latency). Nevertheless, solid-state storage devices could be subject to long read tail latency, which can be explained as follows. The read latency of NAND flash memory is typically tens of microseconds (e.g., 30˜50 μs), while the write and erase latency of NAND flash memory is typically few milliseconds (e.g., 2 ms). When one flash memory chip or die carries out page write or block erase operations, it cannot serve any read operations. As a result, write/erase operations could block subsequent read requests from being served for a long time, leading to long read tail latency.

### SUMMARY

Accordingly, embodiments of the present disclosure are directed to systems and methods for reducing the read tail latency of solid state data storage devices.

A first aspect provides a storage device, comprising: a set of flash memory chips; and a controller that schedules request from a host using a set of request queues, wherein the controller includes a queue manager that: reorders high priority read requests over low priority write requests in each request queue; suspends low priority write requests to process high priority read requests; and limits a number of low priority write requests allowed in each request queue to a threshold value smaller than a size of each request queue.

A second aspect provides a storage infrastructure, comprising: a host; a set of flash memory chips; and a controller that schedules request from the host using a set of request queues, wherein the controller includes a queue manager that: reorders high priority read requests over low priority write requests in each request queue; suspends low priority write requests to process high priority read requests; and limits a number of low priority write requests allowed in each request queue to a threshold value smaller than a size of each request queue.

A third aspect provides a method for scheduling flash memory requests on a controller, comprising: receiving requests from a host; loading the requests into a set of request queues; reordering high priority read requests over low priority write requests in each request queue; suspending low priority write requests to process high priority read requests; and limiting a number of low priority write requests allowed in each request queue to a threshold value smaller than a size of each request queue.

### BRIEF DESCRIPTION OF THE DRAWINGS

The numerous advantages of the present invention may be better understood by those skilled in the art by reference to the accompanying figures in which:

FIG. 1 depicts a storage infrastructure having solid-state storage devices with multiple channels, where each channel associates with one request queue.

FIG. 2 depicts a queue manager having a real tail limiter according to embodiments.

FIG. 3 depicts an operational flow diagram of the invented solution to reduce the tail latency of high-priority read according to embodiments.

FIG. 4 depicts an operational flow diagram of the invented solution to reduce the tail latency of high-priority read according to embodiments.

FIG. 5 depicts an operational flow diagram of a technique to dynamically adjust the limit threshold l_{w} based upon average write throughput according to embodiments.

FIG. 6 depicts the operational flow diagram of a technique to dynamically adjust the limit threshold l_{w} based upon average number of high-priority read requests in the request queue.

### DETAILED DESCRIPTION

Reference will now be made in detail to the presently preferred embodiments of the invention, examples of which are illustrated in the accompanying drawings.

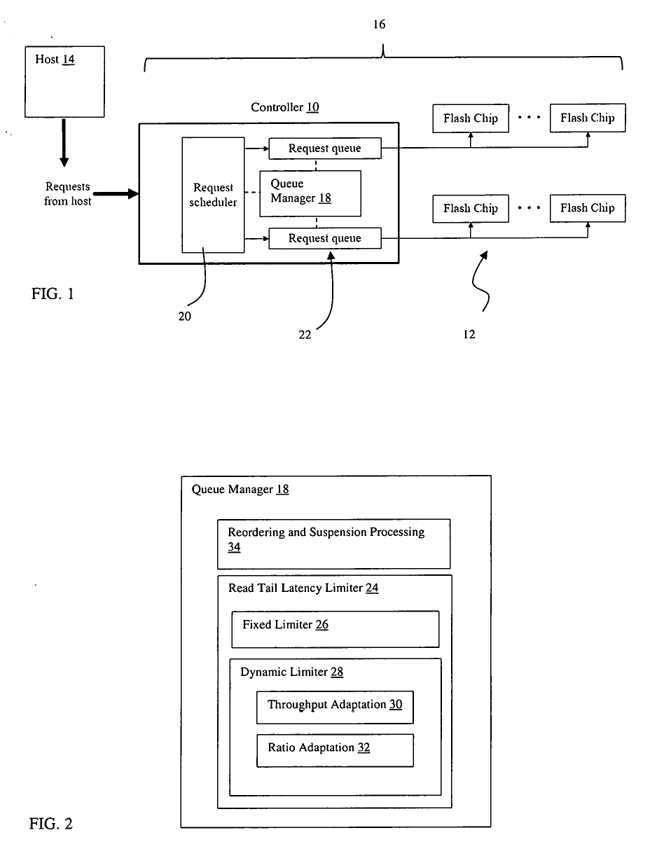

FIG. 1 depicts a storage infrastructure that includes a host 14 and a storage device 16 having a controller 10 and an array of NAND flash memory chips 12. As shown, in order to improve the I/O performance, the controller 10 organizes all the NAND flash memory chips 12 into multiple independent channels. Each channel associates with one request queue 22 that holds a number of pending flash memory read/write/erase requests for flash memory chips 12 on this channel. The controller 10 schedules the processing sequence of all the requests in the request queue 12. In order to reduce the read tail latency, current practice includes a queue manager 18 that employs the following two strategies:
1. Request re-ordering: The queue manager 18 can re-order the requests within each request queue 22 by assigning higher priority to read requests, especially the read requests originated from applications with stringent requirement on read tail latency. The controller 10 always tries to issue those high priority read requests to flash memory chips ahead of other requests (e.g., low-priority read requests and low priority write requests which may include write and write/erase requests) in the same request queue. Since modern solid-state storage devices internally buffer write requests with SRAM/DRAM powered by capacitors, once a host-issued write request enters the request queue in controller 10, its completion acknowledge will be sent back to the host 14 right away. Therefore, the longer write latency due to the request re-ordering is reflected as a longer latency of internal SRAM/DRAM-to-flash data movement, which will not be observed by the host 14 (i.e., it will not degrade the write latency experienced by the host).
2. Low priority write operation suspension: If a high-priority read request enters the request queue 22 but is blocked by an on-going low priority write operation (i.e., a write or write/erase operation), the queue manager 18 can forcefully suspend the on-going low priority write operation in order to make flash memory available to serve the high-priority read operation. Typically there is a limit on how many times one low priority write operation can be suspended. Once the limit has been reached, the low priority write operation cannot be suspended and the incoming high-priority read has to wait until the low priority write operation has finished.

Although effective, the above two design strategies may not be always adequate, especially in the presence of stringent read tail latency constraints. When using either the request re-ordering or low priority write operation suspension, the number of pending low priority write requests within the request queue will gradually increase as the system keeps postponing/suspending low priority write operations in favor of serving high-priority read requests. Once a request queue 22 is filled with low priority write requests (and low-priority read requests if any), the request queue 22 cannot accept any new requests (including high-priority read requests), until at least one pending request within the queue has been successfully processed. This will block high-priority read requests, contributing to read tail latency.

As shown in FIG. 2, the present approach provides an enhanced queue manager 18 having a read tail latency limiter 24 that operates to complement existing request re-ordering and low priority write operation suspension design strategies (shown as reordering and suspension processing 34), to reduce the read tail latency. Read tail latency limiter 24 appropriately limits the number of pending lower priority write requests (i.e., write or write/erase requests) that are allowed in each request queue 22, which prevents too many low priority write requests from dominating the entire request queue 22. This essentially trades the achievable write throughput for lower read tail latency. As described, read tail latency limiter 24 may be implemented with a fixed limiter 26 or a dynamic limiter 28.

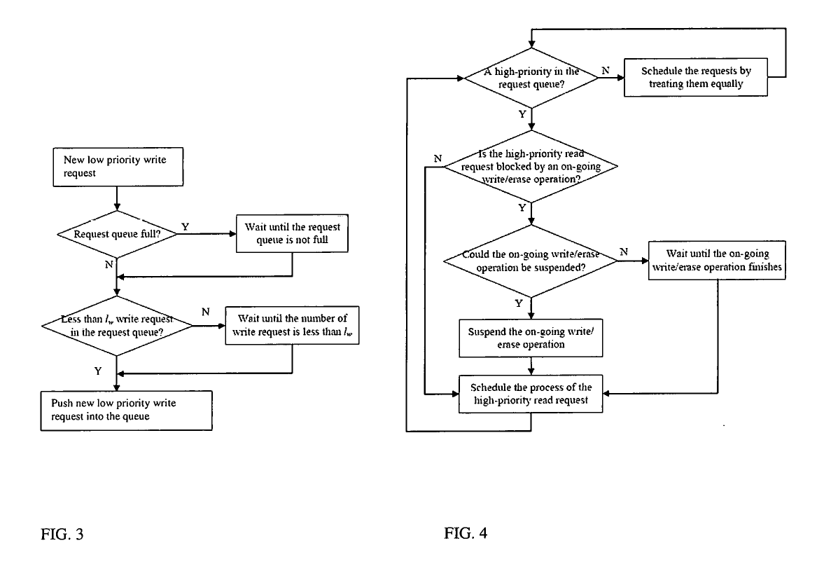

FIG. 3 shows an illustrative operational flow diagram. l_{w} denotes the limit (i.e., threshold value) on the number of pending low priority write requests allowed in each request queue. When a new low priority write request is received, the process first checks whether the request queue is full. If so, the request waits until the request queue is not full. Once there is room, a check is made whether there are less than l_{w} low priority write requests in the request queue. If so, the request waits until the number of low priority write requests in the request queue is less than l_{w}. Once there are less than l_{w} low priority write requests in the queue, the new low priority write request is pushed into the queue.

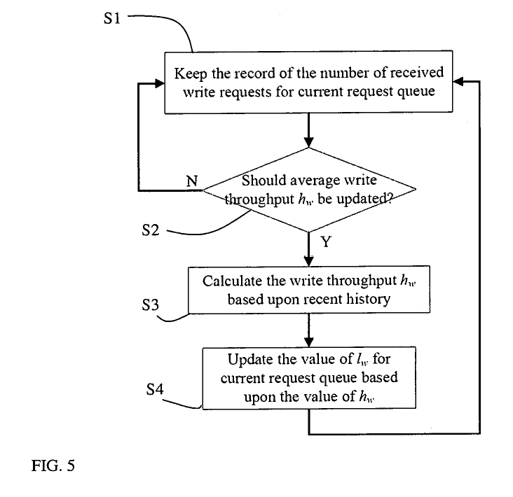

FIG. 4 depicts an illustrative process for suspending low priority write requests when a high priority request is in the request queue. If there are low priority requests in the request queue blocking the high priority request, a determination is made whether the low priority request can be suspended. If yes, the low priority request is suspended and the high priority request is processed. If no, the high priority request waits until the low priority request is processed.

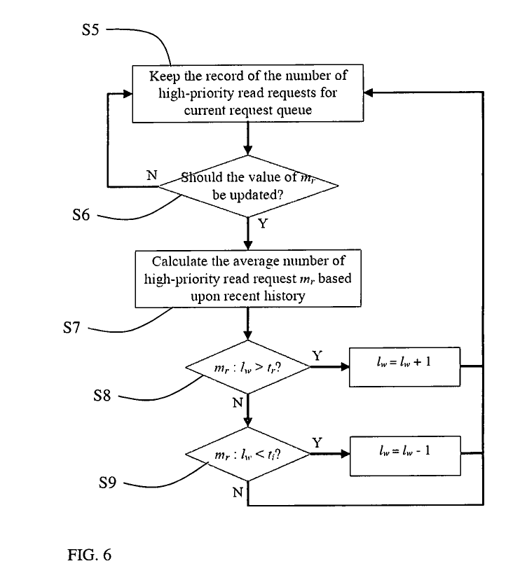

When implementing this approach, an important issue is how to quantitatively determine the threshold value of l_{w}. To address this issue, three illustrative options are described, including using a fixed limiter 26 or a dynamic limiter 28 (FIG. 2).
1. The first option is to simply use the same fixed value of l_{w} for all the request queues in the controller 10. The value of l_{w} is can be determined off-line by running/analyzing a wide range of representative workloads to find a value that provides a suitable balance of reducing read tail latencies without unnecessarily delaying low priority write request processing. For example, in a request queue that can hold 16 requests, the fixed value limit l_{w} may be set to 8 based on a historical analysis.
2. The second option, shown as throughput adaptation 30 in FIG. 2, dynamically adjusts the threshold value of l_{w} for each request queue in adaptation to a runtime average write throughput (denoted as h_{w}). FIG. 5 depicts an illustrative flow in which the queue manager 18 keeps a record of the number of received write requests for each request queue at S1 as requests are processed. At S2, a determination is made whether the average write throughput h_{w} should be updated, e.g., based on a time period being exceeded or a number of transactions processed. If yes, the average write throughput h_{w} for the request queue is calculated at S3 based on recent history at S3 (e.g., what is the average number of write requests processed over a recent series of several second or minute time periods). Based on the average write throughput h_{w} the queue manager 18 accordingly adjusts the value of l_{w} for each request queue whenever the queue manager updates the value of h_{w}. For example, if the average number of write requests h_{w} processed over a series of time periods is 500, then the queue manager may set l_{w} proportional to that value, e.g., h_{w}/50=10.
3. The third option is to dynamically adjust the value of l_{w} for each request queue in adaptation to the ratio between mᵣ and current l_{w}, in which mᵣ denotes the average number of high-priority read requests in one request queue over a recent history. An example flow is shown in FIG. 6, in which the queue manager 18 keeps a record of the number of high-priority read requests in the request queue at S5. At S6, a determination is made whether the average number of read requests mᵣ should be updated, e.g., based on a threshold such as a time period or number of transactions processed. If yes, then mᵣ for the request queue is calculated at S7 based on recent history (e.g., based on last n transactions or all transactions over the past several seconds or minutes). Based on the calculation of mᵣ, l_{w} is updated as follows. If the ratio mᵣ:l_{w} is greater than a first pre-defined threshold tᵣ, the value of l_{w} is incremented by 1; if the ratio mᵣ:l_{w} is less than a pre-defined threshold tᵢ, (where tᵢ<tᵣ) the value of l_{w} is decremented by 1. In this manner, the ratio is dynamically maintained between two predefined values tᵣ and tᵢ. For example, assume the queue manager 18 wants to ensure that the ratio of read requests mᵣ to the write request limit l_{w} is between 2:1 and 1:1, meaning that the average number of read request should be at least equal to, but no more than double, the write request limit. In this case, tᵣ is set to “2” and tᵢ is set to “1”. In a first scenario, assume l_{w} is currently set to 4 and mᵣ is calculated as 10. In this case, the ratio would be 10:4 which is greater than 2 at step S8, so l_{w} would be incremented by 1. In a second scenario, assume that l_{w} is currently set to 6 and mᵣ is calculated as 5. In this case, the ratio would be 5:6 which is less than 1 at step S9, so l_{w} would be decremented by 1.

It is understood that other approaches for dynamically or statically calculating a threshold value l_{w} may be used within the scope of this invention. It is also understood that the controller 10 may be implemented in any manner, e.g., as an integrated circuit board or a controller card that includes a processing core, I/O, processing logic and/or a software program. Aspects may be implemented in hardware or software, or a combination thereof. For example, aspects of the processing logic may be implemented using field programmable gate arrays (FPGAs), ASIC devices, or other hardware-oriented system.

Aspects may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by hardware and/or computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A storage device, comprising:
a set of flash memory chips; and
a controller that schedules request from a host using a set of request queues, wherein the controller includes a queue manager that:
reorders high priority read requests over low priority write requests in each request queue;
suspends low priority write requests to process high priority read requests; and
limits a number of low priority write requests allowed in each request queue to a threshold value smaller than a size of each request queue.

2. The storage device of claim 1, wherein the threshold value is dynamically calculated during a runtime based on an average number of low priority write requests received over a defined period.

3. The storage device of claim 1, wherein the threshold value is dynamically adjusted during a runtime based on a ratio of (1) an average number of high priority read requests received over a defined period; and (2) a current threshold value.

4. The storage device of claim 3, wherein the threshold value is incremented if the ratio is greater than a first predefined value and the threshold value is decremented if the ratio is less than a second predefined value.

5. The storage device of claim 1, wherein the threshold value is static and determined off-line based on a historical analysis.

6. The storage device of claim 1, wherein the low priority write requests include write requests and write/erase requests.

7. A storage infrastructure, comprising:
a host;
a set of flash memory chips; and
a controller that schedules request from the host using a set of request queues, wherein the controller includes a queue manager that:
reorders high priority read requests over low priority write requests in each request queue;
suspends low priority write requests to process high priority read requests; and
limits a number of low priority write requests allowed in each request queue to a threshold value smaller than a size of each request queue.

8. The storage device of claim 7, wherein the threshold value is dynamically calculated during a runtime based on an average number of low priority write requests received over a defined period.

9. The storage device of claim 7, wherein the threshold value is dynamically adjusted during a runtime based on a ratio of (1) an average number of high priority read requests received over a defined period; and (2) a current threshold value.

10. The storage device of claim 9, wherein the threshold value is incremented if the ratio is greater than a first predefined value and the threshold value is decremented if the ratio is less than a second predefined value.

11. The storage device of claim 7, wherein the threshold value is static and determined off-line based on a historical analysis.

12. The storage device of claim 7, wherein the low priority write requests include write requests and write/erase requests.

13. A method for scheduling flash memory requests on a controller, comprising:
receiving requests from a host;
loading the requests into a set of request queues;
reordering high priority read requests over low priority write requests in each request queue;
suspending low priority write requests to process high priority read requests; and
limiting a number of low priority write requests allowed in each request queue to a threshold value smaller than a size of each request queue.

14. The method of claim 13, wherein the threshold value is dynamically calculated during a runtime based on an average number of low priority write requests received over a defined period.

15. The method of claim 13, wherein the threshold value is dynamically adjusted during a runtime based on a ratio of (1) an average number of high priority read requests received over a defined period; and (2) a current threshold value.

16. The method of claim 15, wherein the threshold value is incremented if the ratio is greater than a first predefined value and the threshold value is decremented if the ratio is less than a second predefined value.

17. The method of claim 13, wherein the threshold value is static and determined off-line based on a historical analysis.

18. The method of claim 13, wherein the low priority write requests include write requests and write/erase requests.
